(19) United States
(12) Patent Application Publication
(10) Pub. No.: US 2024/0351837 A1
(43) Pub. Date: Oct. 24, 2024

(54) Travel Restricting Device

(71) Applicant: Daifuku Co., Ltd., Osaka-shi (JP)

(72) Inventors: Tomohiko Kawashima, Hinocho (JP); Masaki Shimazu, Hinocho (JP)

(21) Appl. No.: 18/643,107

(22) Filed: Apr. 23, 2024

(30) Foreign Application Priority Data
Apr. 24, 2023 (JP) 2023-070587

(51) Int. Cl. B66F 9/075

(52) U.S. Cl. CPC B66F 9/07577

(57) ABSTRACT

A travel restricting device is for restricting the traveling of a transport vehicle along a travel rail in a transport facility. The transport vehicle includes a wheel that rolls on a travel surface of the travel rail, a drive device that drives the wheel, and a bumper that causes the drive device to undergo an emergency stop. The travel restricting device includes a mounting section mountable on the travel surface, and a standing section that can be disposed extending upward beyond the travel surface. The standing section includes a facing section arranged at a position facing the bumper from a distancing side in the travel direction while the mounting section is mounted on the travel surface. The mounting section includes an underlay section positioned relative to the facing section so as to be pressed under the wheel while the bumper is in contact with the facing section.

### CROSS-REFERENCE TO RELATED APPLICATION

This application claims priority to Japanese Patent Application No. 2023-070587 filed Apr. 24, 2023, the disclosure of which is hereby incorporated by reference in its entirety.

### BACKGROUND OF THE INVENTION

### 1. Field of the Invention

The present invention relates to a travel restricting device.

### 2. Description of Related Art

Technology related to an automated warehouse is disclosed in WO 2014/129066 (Patent Document 1), for example. In the following description of the related art, the symbols shown in parentheses are those used in Patent Document 1.

In the automated warehouse of Patent Document 1, a transport vehicle (stacker crane 2) is used as a transport device for transporting articles. This transport vehicle includes a lower carriage (4) that travels on a lower rail (12), an upper carriage (6) that travels on an upper rail (14), a mast (8) that is fixed to the lower carriage (4) and connects the lower carriage (4) and the upper carriage (6) to each other, and a transfer device (10) provided on the mast (8). The lower carriage (4) includes wheels (drive wheels 22) and a support section (28) located away from the wheels. Also, the lower carriage (4) is provided with a displacement mechanism. The displacement mechanism raises and lowers the support section (28) between a grounded position where the support section (28) is supported by the lower rail (12) and a retracted position where the support section (28) is lifted up above the lower rail (12). When the transport vehicle operates, the support section (28) is raised to the retracted position. The support section (28) is lowered to the grounded position when installing the transport vehicle on the lower rail (12) and the upper rail (14), and when stopping the transport vehicle in order to perform maintenance.

In the automated warehouse of Patent Document 1, the lower carriage (4) and the mast (8) can be set in a stable orientation by lowering the support section (28) to the grounded position. Therefore, it becomes easier to install the transport vehicle on the rails and to perform maintenance on the transport vehicle. There are cases where a worker needs to move a transport vehicle during such work, and a situation can arise in which the transport vehicle unexpectedly starts to travel while being moved. In such a case, from the viewpoint of ensuring the safety of the worker and avoiding damage to the facility, it is necessary to stop the transport vehicle immediately, but Patent Document 1 does not mention anything regarding this point.

### SUMMARY OF THE INVENTION

In view of the foregoing, there is desire for a travel restricting device that can quickly bring a transport vehicle to an emergency stop in the case where the transport vehicle unexpectedly starts to travel.

A travel restricting device according to an aspect of the present disclosure is configured to restrict traveling of a transport vehicle configured to travel along a travel rail in a transport facility that includes the transport vehicle and the travel rail, the transport vehicle including a wheel configured to roll on a travel surface of the travel rail, a drive device configured to drive the wheel, and a bumper configured to cause the drive device to undergo an emergency stop in response to a collision with an obstacle, the travel restricting device including:
a mounting section configured to be mounted on the travel surface; and
a standing section configured to be fixed to the mounting section and extend upward beyond the travel surface,
with a travel direction being a direction along the travel rail, a distancing side in the travel direction being a side corresponding to movement away from the wheel in the travel direction, and an approaching side in the travel direction being a side corresponding to movement toward the wheel in the travel direction,
the standing section including a facing section configured to be arranged at a position facing the bumper from the distancing side in the travel direction while the mounting section is mounted on the travel surface, and
the mounting section including an underlay section configured to be positioned relative to the facing section in such a manner that the underlay section is pressed under the wheel while the bumper is in contact with the facing section.

According to this configuration, when work is to be performed by a worker or the like in the vicinity of the transport vehicle while the transport vehicle is stopped, the travel restricting device is installed such that the mounting section is mounted on the travel surface, and therefore even if the transport vehicle unexpectedly starts traveling, the transport vehicle can be stopped immediately. In other words, when the transport vehicle travels and the bumper comes into contact with the facing section, the underlay section of the mounting section becomes pressed under the wheel. Since the facing section is fixed to the mounting section, the facing section does not move when pushed by the transport vehicle, and the bumper can be pushed by the facing section. Therefore, the drive device of the transport vehicle can be reliably brought to an emergency stop.

In this way, according to the above configuration, even if the transport vehicle unexpectedly starts traveling, the transport vehicle can be quickly brought to an emergency stop.

Further features and advantages of the travel restricting device will become clearer from the following description of illustrative and non-limiting embodiments given with reference to the drawings.

### BRIEF DESCRIPTION OF THE DRAWINGS

The terms Fig., FIG., Figs., FIGS., Figure, and Figures are used interchangeably to refer to the corresponding figures in the drawings.

FIG. 1 is a perspective view of a travel restricting device.

FIG. 2 is a rear view of the travel restricting device.

FIG. 3 is a plan view schematically showing a traveling carriage section of the transport vehicle.

FIG. 4 is a control block diagram.

FIG. 5 is a side view schematically showing an arrangement of the travel restricting device, a wheel, a bumper, and a wheel support member.

FIG. 6 is a side view schematically showing an arrangement of the travel restricting device, a wheel, a bumper, and a wheel support member.

FIG. 7 is a side view schematically showing an arrangement of the travel restricting device, a wheel, a bumper, and a wheel support member.

FIG. 8 is a side view schematically showing an arrangement of the travel restricting device, a wheel, a bumper, and a wheel support member.

FIG. 9 is a side view schematically showing an upright section in another embodiment.

### DESCRIPTION OF THE INVENTION

Hereinafter, embodiments of a travel restricting device will be described with reference to the drawings by way of example of use in a transport device.

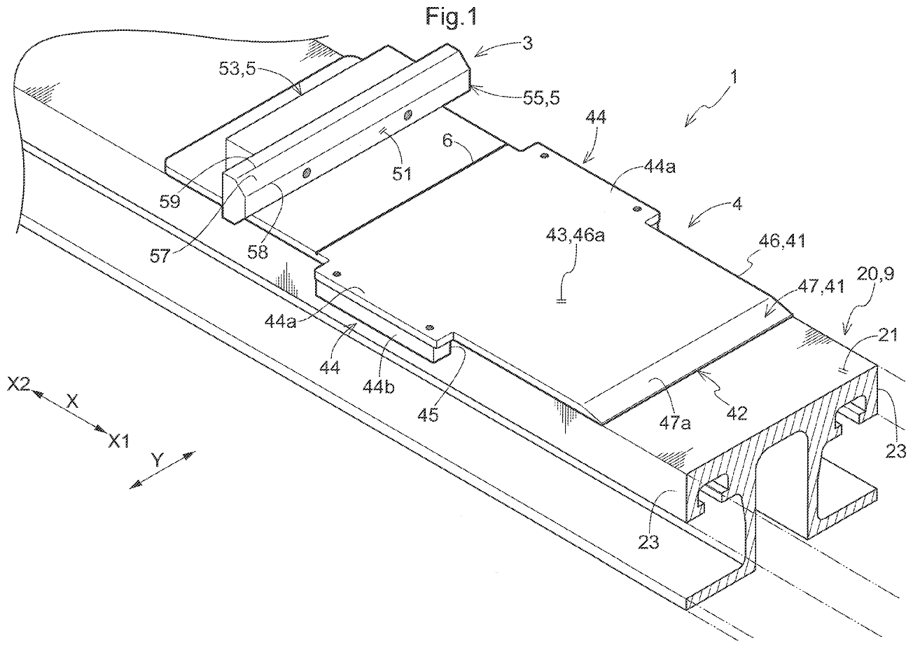

As shown in FIGS. 1 to 4, a transport facility 9 includes travel rails 20 and a transport vehicle 10 that travels along the travel rails 20. In the present embodiment, the transport facility 9 is configured to transport articles. Specifically, the transport vehicle 10 is an article transport vehicle for transporting articles, and transports an article to a predetermined destination by traveling along the travel rails 20. The transport facility 9 is facility that is provided inside an automated warehouse provided with a storage rack for storing articles, and in this facility, articles are stored in the storage rack and retrieved from the storage rack, for example.

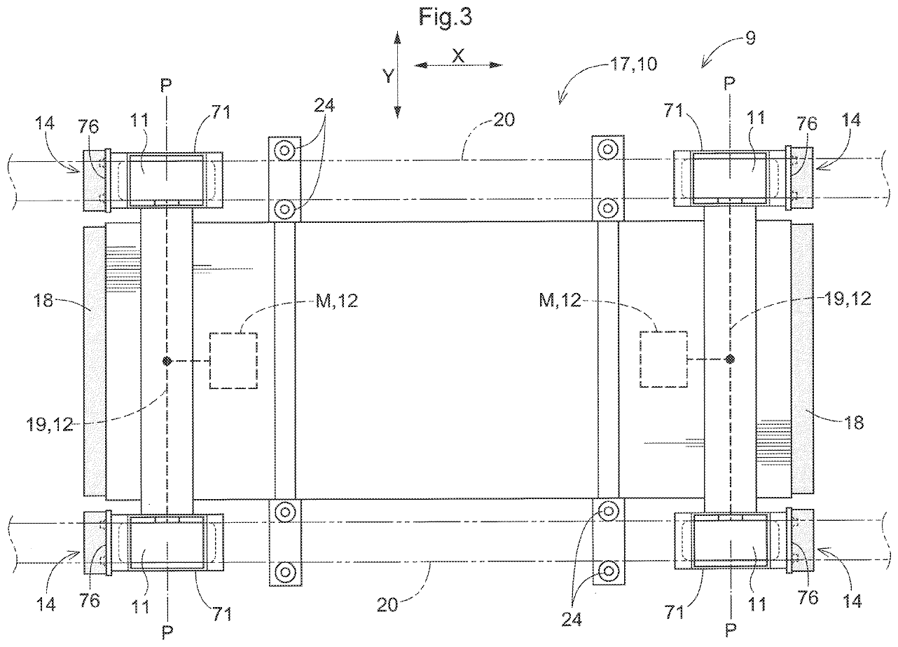

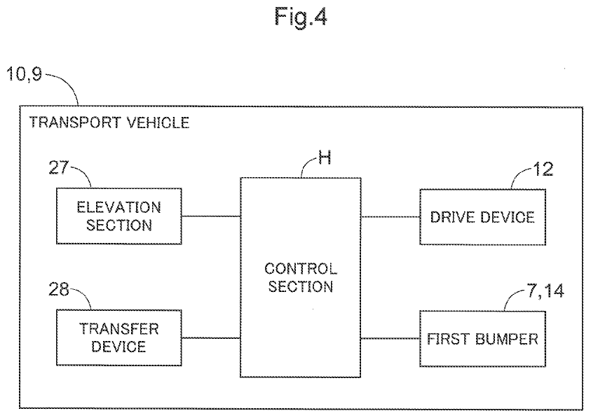

As shown in FIGS. 3 and 4, the transport vehicle 10 includes wheels 11 that roll on travel surfaces 21 of the travel rails 20, a drive device 12 for the wheels 11, and first bumpers 14 for causing the drive device 12 to undergo an emergency stop in response to a collision with an obstacle. In the present embodiment, the transport vehicle 10 includes a plurality of wheels 11 and a plurality of first bumpers 14 respectively corresponding to the wheels 11. In the example shown in FIG. 3, the number of wheels 11 and the number of first bumpers 14 are the same. Note that the first bumpers 14 correspond to a “bumper”.

In the following, as shown in FIG. 1 and FIGS. 5 to 8, a travel direction X is a direction extending along the travel rails 20, a distancing side X2 in the travel direction is the side corresponding to movement away from the wheel 11 in the travel direction X, and an approaching side X1 in the travel direction is the side corresponding to movement toward the wheel 11 in the travel direction X. Also, as shown in FIGS. 1 to 3, a width direction Y is a direction orthogonal to the travel direction X in a vertical view.

In this example, as shown in FIG. 3, a pair of travel rails 20 are provided spaced apart in the width direction Y. The transport vehicle 10 travels in the travel direction X while being guided by the pair of travel rails 20. In this example, the transport vehicle 10 includes a traveling carriage section 17 that moves while being guided by the pair of travel rails 20, a transfer device 28 (FIG. 4), an elevation section 27 (FIG. 4), second bumpers 18, and a control section H (FIG. 4). The wheels 11 are attached to the traveling carriage section 17, and the drive device 12 for driving the wheels 11 and the control section H (FIG. 4) are also provided in the traveling carriage section 17. The second bumpers 18 are also provided on the traveling carriage section 17. In the example shown in FIG. 3, two pairs of wheels 11 are arranged spaced apart in the travel direction X. The two pairs of wheels 11 are spaced apart in the width direction Y so as to correspond to the pair of travel rails 20. In other words, each pair of wheels 11 spaced apart in the travel direction X roll on the travel surface 21 of one travel rail 20. Here, the wheels 11 are attached to the traveling carriage section 17 via wheel support members 71. Also, in the example shown in FIG. 3, guide wheels 24 corresponding to the pair of travel rails 20 are provided on the traveling carriage section 17. Each set of guide wheels 24 is arranged so as to sandwich the corresponding travel rail 20 in the width direction Y.

The drive device 12 includes a travel motor M (electric motor) and a transmission mechanism 19 that transmits driving force from the travel motor M to the wheels 11. In the example shown in FIG. 3, a pair of one travel motor M and one transmission mechanism 19 is provided for each pair of wheels 11 spaced apart in the travel direction X. Due to the driving of the drive device 12, the wheels 11 roll on the travel surfaces 21 of the travel rails 20, and the guide wheels 24 rotate around axes extending along the vertical direction, and thus the traveling carriage section 17 moves along the travel direction X.

The transfer device 28 is configured to hold an article being transported and to transfer the article to and from a transfer target location. The transfer device 28 holds the article placed thereon, and also transfers the article to or from the transfer target location by loading or unloading the article in the width direction Y. In this example, the transfer device 28 is a conveyor type of device, but may instead be a slide fork type of device or the like. Here, the transfer device 28 is provided in the elevation section 27. In this example, the transport vehicle 10 is a stacker crane. For this reason, a mast (not shown) is provided on the traveling carriage section 17 so as to extend along the vertical direction. The elevation section 27 is configured to be above to move up and down along the mast.

Note that the transport vehicle 10 is not limited to being a stacker crane, and may be a transport carriage (so-called shuttle carriage) for the placement and transport of articles. In this case, the transfer device 28 can also be provided in the traveling carriage section 17. Also, the transport vehicle 10 may be a parent carriage on which a child carriage that travels in the width direction Y and transports articles can be mounted, or may be an overhead transport vehicle that travels while being guided by a rail that is suspended from the ceiling.

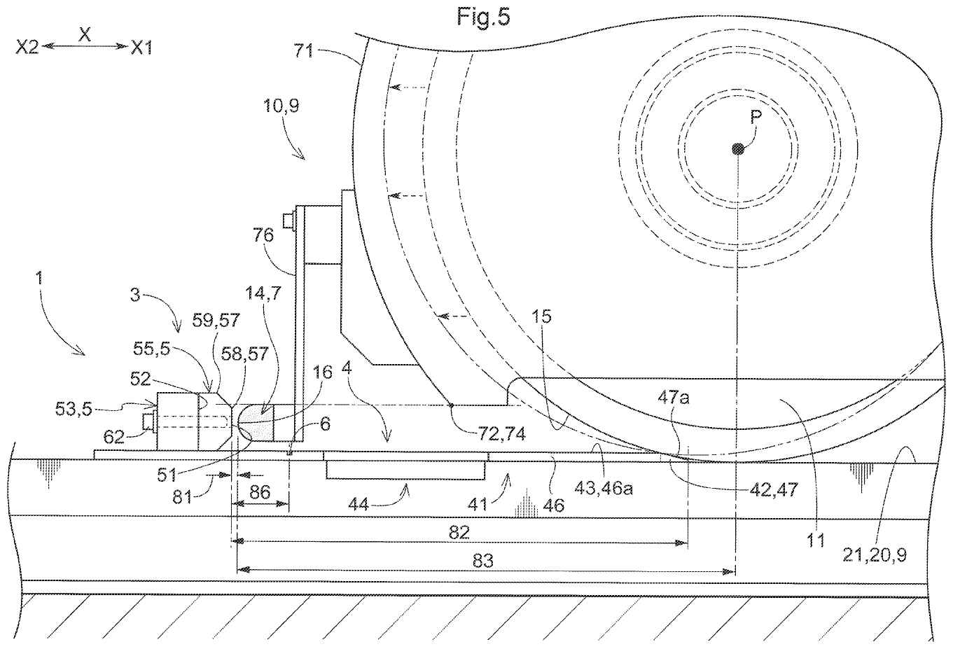

As shown in FIG. 3, the wheel support members 71 are provided on the traveling carriage section 17, and support the wheels 11 so as to be able to rotate around an axis P extending along the width direction Y. Here, each of the wheel support members 71 is formed so as to cover both sides of the corresponding wheel 11 in the travel direction X and the outer side of the corresponding wheel 11 in the width direction Y (the side on the traveling carriage section 17 is not arranged). In this example, a lower end portion 74 of the wheel support member 71 is a lower end portion 72 of the wheel support member 71 on the distancing side X2 in the travel direction. Of course, the lower end portion 74 of the wheel support member 71 is set so as to be higher than the lower end of the wheel 11. Note that in the example shown in FIGS. 5 to 8, the wheel support member 71 is circular, but the present invention is not limited to this.

As shown in FIG. 3, a plurality of first bumpers 14 are arranged respectively corresponding to the wheels 11. Also, each of the first bumpers 14 is arranged on the distancing side X2 of the corresponding wheel 11 and wheel support member 71 in the travel direction. In this example, the first bumper 14 is fixed to the wheel support member 71 via a bumper support member 76. In the example shown in FIG. 3, a total of four first bumpers 14 are arranged respectively corresponding to the two pairs of wheels 11. The first bumpers 14 are arranged so as to protrude in the travel direction X beyond at least the traveling carriage section 17, the wheels 11, and the wheel support members 71 of the transport vehicle 10 in a vertical view. If an object such as an obstacle is located on one of the travel rails 20 in front of the transport vehicle 10 in the travel direction, a corresponding first bumper 14 will, in principle, come into contact with the object.

In the present embodiment, the transport vehicle 10 further includes switch sections 7. The switch sections 7 are each configured to be turned on in the case where, for example, an obstacle or the like on one of the travel rails 20 in front of the transport vehicle 10 in the travel direction comes into contact with a first bumper 14. When the switch section 7 switches from the off state to the on state, the supply of power to the drive device 12 is cut off, and the transport vehicle 10 stops. In this example, each of the first bumpers 14 has a switch function. In other words, the first bumper 14 itself serves as the switch section 7. Specifically, when the leading of the first bumper 14 comes into contact with another object and is pushed inward (the approaching side X1 in the travel direction) while the transport vehicle 10 is traveling, the transport vehicle 10 stops. Due to having such a switch function, when the transport vehicle 10 collides with an object on one of the travel rails 20, the first bumper 14 can have not only the original function of protecting the wheel 11, the wheel support member 71, and the traveling carriage section 17 from the impact, but also a function of bringing the transport vehicle 10 to an emergency stop. Note that the switch section 7 can also be provided separately from the first bumper 14. For example, the switch section 7 may be provided on the traveling carriage section 17, the wheel support member 71, or the like.

As shown in FIG. 3, the second bumpers 18 are arranged on the two outer sides of the traveling carriage section 17 in the travel direction X. Also, the second bumpers 18 are arranged between the pair of travel rails 20. In the example shown in FIG. 3, each of the two second bumpers 18 is arranged between a pair of first bumpers 14 that are separated in the width direction Y. Furthermore, although the second bumper 18 and the corresponding pair of first bumpers 14 are located at the same position in the travel direction X, they may be arranged at positions shifted from each other in the travel direction X. In this example, when the transport vehicle 10 collides with an obstacle or the like in front of the transport vehicle 10 in the travel direction, the second bumper 18 has a function of protecting the traveling carriage section 17 and the like from the impact, but, unlike the first bumper 14, does not have a function of bringing the transport vehicle 10 to an emergency stop. However, the second bumper 18 may also be provided with a function for bringing the transport vehicle 10 to an emergency stop. For example, the transport vehicle 10 may be brought to an emergency stop by providing the second bumper 18 with a switch function, or by providing a sensor or the like that detects an object ahead in the travel direction.

For example, upon receiving command information from a host controller that performs overall control of the automated warehouse (not shown), the control section H controls the elevation section 27, the transfer device 28, and the drive devices 12 based on the command information. Furthermore, when a first bumper 14 switches from the off state to the on state, the control section H cuts off the supply of power to the drive devices 12 and stops the transport vehicle 10. The control section H includes a processor such as a microcomputer and peripheral circuits such as a memory, and performs the functions described above through cooperation between such hardware and a program executed on hardware such as the processor.

As shown in FIG. 1 and FIGS. 5 to 8, the travel restricting device 1 restricts the travel of the transport vehicle 10. The travel restricting device 1 is placed on the travel surface 21 of a travel rail 20 such that the transport vehicle 10 cannot travel beyond the travel restricting device 1. Specifically, the travel restricting device 1 is arranged on the distancing side X2 of a wheel 11 in the travel direction so as to face that wheel 11 of the transport vehicle 10. For example, when a worker performs maintenance work on the transport vehicle 10 (here, a stacker crane), the travel restricting device 1 is placed on the travel surface 21 so as to correspond to a wheel 11 of the transport vehicle 10 in a stopped state. In this example, the transport vehicle 10 includes a plurality of (here, four) wheels 11. The worker may use a plurality of travel restricting devices 1 in correspondence with all of the wheels 11, or may use one or more travel restricting devices 1 in correspondence with one or more of the wheels 11. For example, one or more travel restricting devices 1 may be used so as to correspond only to the wheels 11 disposed on one travel rail 20 out of the two travel rails 20. Here, the travel restricting device 1 includes a mounting section 4 that can be mounted on the travel surface 21, and an upright section 3 that can be fixed to the mounting section 4 and extend upward beyond the travel surface 21. In the present embodiment, the upright section 3 is configured to come into contact with the above-described first bumper 14 when the transport vehicle 10 travels toward the travel restricting device 1. Also, the mounting section 4 is a plate-shaped member, and is configured such that when the transport vehicle 10 travels toward the travel restricting device 1, the wheel 11 rides onto the mounting section 4 from the travel rail 20. The specific configuration of the travel restricting device 1 will be described below.

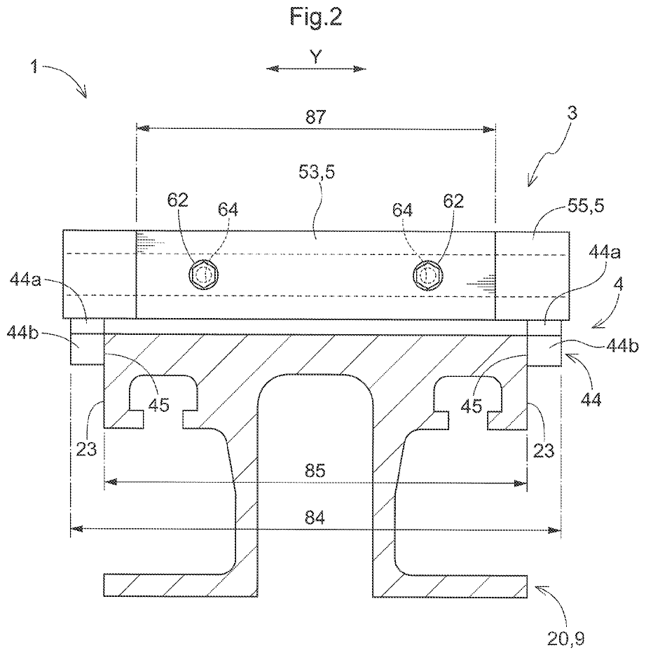

As shown in FIGS. 1, 2, and 5, the upright section 3 includes a facing section 5 located at a position facing the first bumper 14 from the distancing side X2 in the travel direction when the mounting section 4 is mounted on the travel surface 21. When the transport vehicle 10 travels toward the travel restricting device 1, the facing section 5 comes into contact with the first bumper 14. In the present embodiment, the vertical length of the facing section 5 is set to correspond to the vertical position of the first bumper 14. In the present embodiment, as shown in FIGS. 1, 2, and 5, the facing section 5 includes a fixed facing member 53 that is fixed to the mounting section 4, and a detachable facing member 55 detachably attached to the mounting section 4 on the approaching side X1 of the fixed facing member 53 in the travel direction. In this example, the fixed facing member 53 and the detachable facing member 55 are both a member shaped as a polygonal prism. The detachable facing member 55 is attached to the fixed facing member 53 such that the surface of the detachable facing member 55 that faces the distancing side X2 in the travel direction abuts against the surface of the fixed facing member 53 that faces the approaching side X1 in the travel direction (later-described auxiliary facing surface 52). Here, the detachable facing member 55 is fixed to the fixed facing member 53 by fastening members 62. More specifically, as shown in FIG. 2, insertion holes 64 are formed in the back surface of the fixed facing member 53 (here, the surface facing the distancing side X2 in the travel direction). By inserting the fastening members 62 into the insertion holes 64 and performing tightening, the detachable facing member 55 is fixed to the fixed facing member 53. Also, by performing the reverse procedure, the detachable facing member 55 can be removed from the fixed facing member 53. In this way, the detachable facing member 55 is not fixed to the mounting section 4, and is fixed to only the fixed facing member 53. Note that the detachable facing member 55 may be attached to the fixed facing member 53 by a configuration other than the fastening members 62. Furthermore, the detachable facing member 55 may be fixed to a portion of the travel restricting device 1 other than the fixed facing member 53 (e.g., the mounting section 4).

As shown in FIG. 1 and FIGS. 5 to 8, the detachable facing member 55 includes a facing surface 51 that faces the first bumper 14 from the distancing side X2 in the travel direction. The facing surface 51 is the surface of the detachable facing member 55 that faces the approaching side X1 in the travel direction. In the example shown in FIG. 5, the facing surface 51 is the surface of the detachable facing member 55 formed farthest on the approaching side X1 in the travel direction, and extends along the vertical direction and the width direction Y. In the present embodiment, the facing surface 51 is arranged so as to correspond to the vertical position of the first bumper 14. Here, the facing surface 51 is arranged such that when the transport vehicle 10 travels toward the travel restricting device 1, an end portion 16 of the first bumper 14 on the distancing side X2 in the travel direction comes into contact with a vertically central portion of the facing surface 51.

As shown in FIG. 1 and FIGS. 5 to 8, the facing section 5 includes an inclined upper surface 57, which is an upper surface that is inclined upward while extending toward the distancing side X2 in the travel direction. In this example, the inclined upper surface 57 is formed on the detachable facing member 55. Also, the inclined upper surface 57 is formed so as to extend in a continuous manner from the upper end of the facing surface 51. Here, the inclined upper surface 57 is a surface that is inclined upward while extending toward the distancing side X2 in the travel direction from the upper end of the facing surface 51. In the example shown in FIG. 5, the upper surface of the detachable facing member 55 that extends along the horizontal plane extends in a continuous manner from the upper end of the inclined upper surface 57 (an end portion 59 on the travel direction distancing side X2). In the present embodiment, as shown in FIG. 5, an end portion 58 of the inclined upper surface 57 on the approaching side X1 in the travel direction is lower than a lower end portion 72, on the distancing side X2 in the travel direction, of the wheel support member 71 that supports the wheel 11 of the transport vehicle 10. Also, the end portion 59 of the inclined upper surface 57 on the distancing side X2 in the travel direction is higher than the lower end portion 72 of the wheel support member 71 on the distancing side X2 in the travel direction. In other words, the vertical position of the inclined upper surface 57 is set such that the vertical position of the lower end portion 72 of the wheel support member 71 on the distancing side X2 in the travel direction is within the vertical range of the inclined upper surface 57. Furthermore, in the present embodiment, the vertical position of the inclined upper surface 57 is set such that when the wheel 11 rides onto the upper surface 43 of the mounting section 4 from the travel surface 21, the vertical position of the lower end portion 72 of the wheel support member 71 on the distancing side X2 in the travel direction is within the vertical range of the inclined upper surface 57. In this way, the end portion 58 of the inclined upper surface 57 on the approaching side X1 in the travel direction is lower than the lower end portion 72 of the wheel support member 71 on the distancing side X2 in the travel direction in both the state where the wheel 11 is on the travel surface 21 and the state where the wheel 11 is on the upper surface 43 of the mounting section 4, and the end portion 59 of the inclined upper surface 57 on the distancing side X2 in the travel direction is higher than the lower end portion 72 of the wheel support member 71 on the distancing side X2 in the travel direction in both the state where the wheel 11 is on the travel surface 21 and the state where the wheel 11 is on the upper surface 43 of the mounting section 4.

Furthermore, in the example shown in FIG. 5, an inclined surface is formed so as to be inclined downward from the lower end of the facing surface 51 while extending toward the distancing side X2 in the travel direction from the lower end of the facing surface 51. A bottom surface of the detachable facing member 55 extends in a continuous manner from the lower end of this inclined surface. In the illustrated example, the detachable facing member 55 is a member shaped as a polygonal prism (specifically, a hexagonal prism), but the present invention is not limited to this. The detachable facing member 55 may be a plate-like member or may be a member that has roundness. Also, the facing surface 51 is not limited to being a surface that extends along the vertical direction and the width direction Y, and may be formed as a surface having roundness so as to conform to the shape of the first bumper 14, for example.

As shown in FIG. 2, in the present embodiment, a width 84 of the detachable facing member 55 in the width direction Y is larger than a width 85 of the travel rail 20 in the width direction Y. Also, in this example, the width 84 in the width direction Y of the detachable facing member 55 is larger than a width 87 in the width direction Y of the fixed facing member 53. Accordingly, the detachable facing member 55 is arranged so as to protrude from both sides the travel rail 20 and the fixed facing member 53 in the width direction Y when viewed in the travel direction X. Note that in the illustrated example, the width 87 of the fixed facing member 53 in the width direction Y is smaller than the width 85 of the travel rail 20 in the width direction Y, but the present invention is not limited to this.

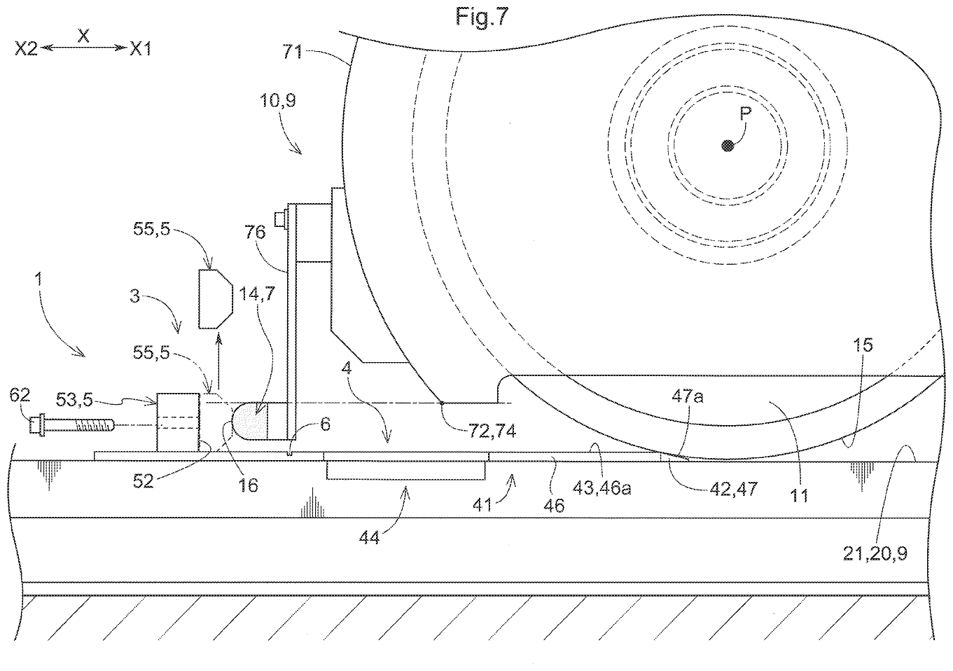

As shown in FIGS. 5 to 8, the fixed facing member 53 includes an auxiliary facing surface 52 that faces the first bumper 14 from the distancing side X2 in the travel direction while the detachable facing member 55 has been detached. In this example, the auxiliary facing surface 52 is the surface of the fixed facing member 53 that faces the approaching side X1 in the travel direction, and extends along the vertical direction and the width direction Y. As shown in FIG. 7, while the detachable facing member 55 is not present, the auxiliary facing surface 52 comes into contact with the first bumper 14 when the transport vehicle 10 travels toward the travel restricting device 1. In the present embodiment, the auxiliary facing surface 52 is arranged so as to correspond to the vertical position of the first bumper 14. The auxiliary facing surface 52 is configured such that when the transport vehicle 10 travels toward the travel restricting device 1, the end portion 16 of the first bumper 14 on the distancing side X2 in the travel direction comes into contact with the vertically central portion of the auxiliary facing surface 52. In the illustrated example, the fixed facing member 53 is a member shaped as a polygonal prism. More specifically, the fixed facing member 53 is a member shaped as a quadrangular prism. Note that the fixed facing member 53 may be a plate-like member or may be a member having roundness. Also, the auxiliary facing surface 52 is not limited to being a surface that extends along the vertical direction and the width direction Y, and may be formed as a surface having roundness so as to conform to the shape of the first bumper 14, for example. Note that the fixed facing member 53 is fixed to the mounting section 4 via a coupling member (not shown). For example, the upright section 3 includes an L-shaped metal fitting as a coupling member, and the fixed facing member 53 is fixed to the mounting section 4 via the L-shaped metal fitting and a fastening member or the like. Also, the fixed facing member 53 may be directly fixed to the mounting section 4 with a fastening member or the like, or may be fixed by other means. Also, the fixed facing member 53 and the mounting section 4 may be formed as a single piece.

As shown in FIG. 1, the mounting section 4 is formed as a flat plate-shaped member. Also, the width of the mounting section 4 in the width direction Y is set according to the widths of the travel surface 21 of the travel rail 20 and the wheel 11 in the width direction Y. In the example shown in FIG. 1, the mounting section 4 is shaped as a rectangle elongated in the travel direction X in a vertical view. Also, the width of the mounting section 4 in the width direction Y is the same as the width of the travel surface 21 in the width direction Y. In the example shown in FIG. 3, the width of the wheel 11 in the width direction Y is the same as the width of the travel surface 21 in the width direction Y. Therefore, the width of the mounting section 4 in the width direction Y is the same as the width of the wheel 11 in the width direction Y. Note that the mounting section 4 may have another shape, such as a wedge shape. Also, in the present embodiment, as shown in FIGS. 1 and 2, the mounting section 4 includes a pair of guide sections 44 arranged outward of the travel rail 20 on opposite sides in the width direction Y (CL6). Also, each of the guide sections 44 includes a guide surface 45 that faces a corresponding side surface 23 of the travel rail 20. The pair of guide sections 44 are provided on the mounting section 4 so as to be separated in the width direction Y. In this example, each of the guide sections 44 includes a guide support section 44a and a block section 44b. When the travel restricting device 1 is placed on the travel surface 21 of the travel rail 20, the pair of guide support sections 44a are arranged so as to protrude outward of the mounting section 4 and the travel surface 21 on opposite sides in the width direction Y. In the illustrated example, the pair of guide support sections 44a are integrated with the mounting section 4. Also, the guide support sections 44a each extend outward in the width direction Y from a portion of the corresponding end portion of the mounting section 4 in the width direction Y. Here, the guide support section 44a supports the block section 44b from above. The block section 44b is disposed below the mounting section 4 and extends along the side surface 23 of the travel rail 20. The guide surface 45 is the surface of the block section 44b that faces inward in the width direction Y (toward the travel rail 20). When the travel restricting device 1 is placed on the travel surface 21 of the travel rail 20, the guide surface 45 of the pair of guide sections 44 come into contact with the side surfaces 23 of the travel rail 20. This restricts movement of the travel restricting device 1 in the width direction Y. Therefore, the travel restricting device 1 can be stably attached to the travel rail 20.

As shown in FIG. 1 and FIGS. 5 to 8, the mounting section 4 includes an underlay section 41 positioned relative to the facing section 5 so as to be pressed under the wheel 11 while the first bumper 14 is in contact with the facing section 5. The underlay section 41 is a region of the mounting section 4 on the approaching side X1 of the upright section 3 in the travel direction. In the present embodiment, the underlay section 41 includes a plate-shaped section 46 that is plate-shaped and extends along the travel surface 21, and a tapered section 47 that is arranged on the approaching side X1 of the plate-shaped section 46 in the travel direction and has an upper surface 47a that is inclined downward while extending toward the approaching side X1 in the travel direction. In this example, the plate-shaped section 46 and the tapered section 47 are integrated with the other portions of the mounting section 4. When the transport vehicle 10 travels toward the travel restricting device 1, one of the wheels 11 first rides onto the upper surface 47a of the tapered section 47 from the travel surface 21. Thereafter, the wheel 11 moves from the upper surface 47a of the tapered section 47 to the upper surface 46a of the plate-shaped section 46. Note that in this example, as shown in FIGS. 1 and 5 to 8, the underlay section 41 is the entire region of the mounting section 4 that is on the approaching side X1 of the upright section 3 in the travel direction, but the underlay section 41 may be only the end portion region of the mounting section 4 on the approaching side X1 in the travel direction.

In the present embodiment, a distance 82 in the travel direction X between the facing surface 51, which faces the first bumper 14, of the facing section 5 and a leading end portion 42 of the underlay section on the approaching side X1 in the travel direction is set such that, while the underlay section 41 is not pressed under the wheel 11 and furthermore the leading end portion 42 of the underlay section on the approaching side X1 in the travel direction is in contact with an outer circumferential surface 15 of the wheel 11, the facing surface 51 and the first bumper 14 are in contact with each other, or the facing surface 51 and the first bumper 14 face each other across a gap 81.

As shown in FIG. 5, in this example, the distance 82 in the travel direction X between the facing surface 51 and the leading end portion 42 of the underlay section 41 on the approaching side X1 in the travel direction is set such that, while the underlay section 41 is not pressed under the wheel 11 and furthermore the leading end portion 42 of the underlay section 41 on the approaching side X1 in the travel direction is in contact with the outer circumferential surface 15 of the wheel 11, the facing surface 51 and the first bumper 14 face each other across the gap 81. Here, the leading end portion 42 of the underlay section 41 on the approaching side X1 in the travel direction is the tapered section 47. In this way, while the wheel 11 is in contact with the tapered section 47 of the underlay section 41, but the underlay section 41 is not pressed under the wheel 11 (while the lower end of the wheel 11, which is directly below the axis P of the wheel 11, is directly supported by the travel surface 21), the first bumper 14 is spaced apart from the facing surface 51 of the detachable facing member 55 by the gap 81. Therefore, in this example, when the wheel 11 moves toward the facing surface 51 by a distance corresponding to the gap 81 (dashed-line arrow in FIG. 5) and rides onto the underlay section 41 such that the underlay section 41 is pressed under the wheel 11, the first bumper 14 and the facing surface 51 come into contact with each other (two-dot chain line in FIG. 5). Also, when the wheel 11 moves by a predetermined pushing amount such that the switch of the first bumper 14 switches from the off state to the on state, the supply of power to the drive device 12 that drives the wheel 11 is cut off.

In this example, an allowable travel distance 86 is the upper limit distance that the transport vehicle 10 is allowed to travel, and the gap 81 is set less than or equal to the allowable travel distance 86. Here, the allowable travel distance 86 is set in consideration of a distance that prevents damage to the travel restricting device 1 and the transport vehicle 10 when a collision occurs between the facing surface 51 and the first bumper 14. Specifically, if the transport vehicle 10 starts traveling from a stopped state and travels beyond the allowable travel distance 86, and the facing surface 51 and the first bumper 14 collide with each other, there is a risk that the travel restricting device 1 and the transport vehicle 10 will become damaged. Therefore, in order to avoid such a situation, the allowable travel distance 86 is set in advance. In order to perform maintenance on the transport vehicle 10, the worker arranges the travel restricting device 1 such that the outer circumferential surface 15 of the wheel 11 comes into contact with the upper surface 47a of the tapered section 47, and therefore even if the transport vehicle 10 unexpectedly starts to travel, it is possible to suppress the traveling of the transport vehicle 10 to a minimum while also bringing the transport vehicle 10 to an emergency stop. Here, the wheel 11 moves by a distance corresponding to the gap 81, which is less than or equal to the allowable travel distance 86, and the predetermined pushing amount of the first bumper 14, thus making it possible to bring the transport vehicle 10 to an emergency stop with a minimum amount of movement and without allowing damage to the travel restricting device 1 and the transport vehicle 10. Note that in the example shown in FIG. 5, the gap 81 is set smaller than the allowable travel distance 86.

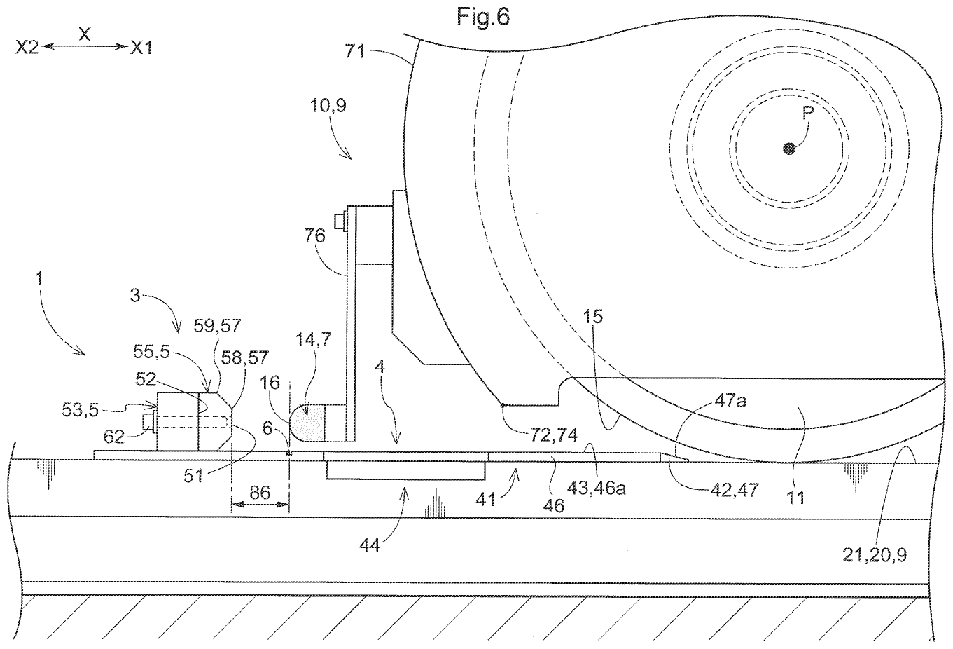

In the present embodiment, as shown in FIG. 1 and FIGS. 5 to 8, the upper surface 43 of the mounting section 4 is provided with a reference mark 6 that indicates a reference for an installation position of the mounting section 4 relative to the first bumper 14. The reference mark 6 is arranged at a position spaced apart from the facing surface 51, which faces the first bumper 14, of the facing section 5 by the allowable travel distance 86. In the illustrated example, a scribing line is provided as the reference mark 6 on the approaching side X1 of the facing surface 51 in the travel direction. Specifically, a groove extending along the width direction Y is formed in the upper surface 46a of the plate-shaped section 46 of the underlay section 41, and the groove is the scribing line serving as the reference mark 6. As shown in FIG. 6, by placing the travel restricting device 1 on the travel surface 21 such that the reference mark 6 is aligned with the end portion of the first bumper 14 on the distancing side X2 in the travel direction, the worker can perform maintenance work while moving the transport vehicle 10 within a range corresponding to the allowable travel distance 86. In other words, in this example, the allowable travel distance 86 is set in consideration of the distance that the worker moves the transport vehicle 10 during maintenance work. In the example shown in FIG. 6, while the travel restricting device 1 is arranged on the travel surface 21 such that the position spaced apart from the facing surface 51 by the allowable travel distance 86 (i.e., the position of the reference mark 6) is aligned with the end portion of the first bumper 14 on the distancing side X2 in the travel direction, the wheel 11 is directly supported by the travel surface 21 without being in contact with the underlay section 41.

Also, the distance 82 in the travel direction X between the facing surface 51, which faces the first bumper 14, of the facing section 5 and the leading end portion 42 of the underlay section on the approaching side X1 in the travel direction is less than or equal to a distance 83 between the axis P of the wheel 11 and the end portion 16 of the first bumper 14 on the distancing side X2 in the travel direction. In this example, as shown in FIG. 5, the distance 82 in the travel direction X between the facing surface 51 and the leading end portion 42 (here, the tapered section 47) is set smaller than the distance 83 between the axis P of the wheel 11 and the end portion 16 of the first bumper 14 on the distancing side X2 in the travel direction.

FIG. 7 shows an example of a process for removing the detachable facing member 55 from the fixed facing member 53 in the case where, during maintenance work or the like, the stopped transport vehicle 10 unexpectedly starts to travel, and the first bumper 14 and the facing surface 51 come into contact with each other. In FIG. 7, the transport vehicle 10 is stopped due to the first bumper 14 switching from the off state to the on state. Also, the underlay section 41 (here, the tapered section 47) is being pressed under the wheel 11. The travel restricting device 1 is thus in a state of being fixed to the travel rail 20. Also, a load acting in the travel direction X is being applied to the detachable facing member 55 by the first bumper 14. In such a case, the detachable facing member 55 can be detached from the fixed facing member 53 by removing the fastening member 62 and then lifting the detachable facing member 55 from below. As shown in FIGS. 1 and 2, the two end portions of the detachable facing member 55 protrude outward of the travel rail 20 on opposite sides in the width direction Y, and therefore the detachable facing member 55 can be relatively easily detached from the fixed facing member 53 by using a tool or the like to push up the two end portions of the detachable facing member 55 from below. This is particularly useful when the transport vehicle 10 does not operate due to a failure or the like in FIG. 7. Also, in the example shown in FIG. 7, if the transport vehicle 10 unexpectedly starts to travel again after the detachable facing member 55 has been detached from the fixed facing member 53, the auxiliary facing surface 52 of the fixed facing member 53 comes into contact with the first bumper 14. As a result, even if the transport vehicle 10 unexpectedly resumes traveling while the detachable facing member 55 is not attached, the first bumper 14 comes into contact with the auxiliary facing surface 52 and switches on again, thus making it possible to stop the transport vehicle 10.

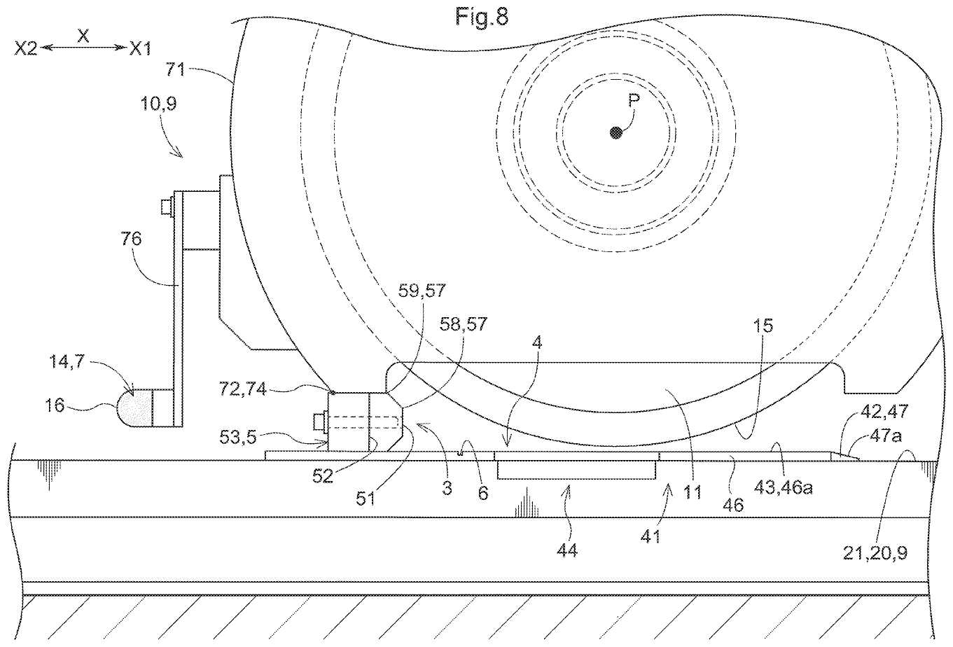

FIG. 8 shows an example of a state in which the transport vehicle 10 starts traveling toward the facing surface 51, and the first bumper 14 travels over and beyond the facing section 5 (detachable facing member 55, fixed facing member 53). As described above, the vertical position of the inclined upper surface 57 is set such that, when the wheel 11 rides onto the upper surface 43 of the mounting section 4 from the travel surface 21, the vertical position of the lower end portion 72 of the wheel support member 71 on the distancing side X2 in the travel direction is within the vertical range of the inclined upper surface 57. Therefore, if the transport vehicle 10 travels such that the first bumper 14 travels over and beyond the facing section 5, the lower end portion 72 of the wheel support member 71 on the distancing side X2 in the travel direction comes into contact with the inclined upper surface 57 and rides onto the upper surface of the facing section 5 while being guided by the inclined upper surface 57. As a result, the wheel 11 supported by the wheel support member 71 also rises, and the lower end of the wheel 11 becomes lifted up above the travel surface 21 and the upper surface 43 of the mounting section 4. Therefore, the transport vehicle 10 can be prevented from traveling any more relative to the facing section 5 in the distancing side X2 in the travel direction.

### OTHER EMBODIMENTS

(1) In the above-described embodiment, the traveling carriage section 17 is guided by the pair of travel rails 20 while traveling, but the present invention is not limited to this. For example, the traveling carriage section 17 may travel while being guided by a single travel rail 20.

(2) In the above embodiment, an example is described in which the distance in the travel direction X between the facing surface 51 and the leading end portion 42 of the underlay section on the approaching side X1 in the travel direction is set such that, while the underlay section 41 is not pressed under the wheel 11 and furthermore the leading end portion 42 of the underlay section on the approaching side X1 in the travel direction is in contact with the outer circumferential surface 15 of the wheel 11, the facing surface 51 and the first bumper 14 face each other across the gap 81, but the present invention is not limited to this. The distance in the travel direction X between the facing surface 51 and the leading end portion 42 of the underlay section on the approaching side X1 in the travel direction may be set such that, while the underlay section 41 is not pressed under the wheel 11 and furthermore the leading end portion 42 of the underlay section on the approaching side X1 in the travel direction is in contact with the outer circumferential surface 15 of the wheel 11, the facing surface 51, which faces the first bumper 14, of the facing section 5 is in contact with the first bumper 14. In other words, in FIG. 5, the distance in the travel direction X between the facing surface 51 and the leading end portion 42 (here, the tapered section 47) can also be set such that the gap 81 is not formed, and the facing surface 51 and the first bumper 14 are in contact with each other. In particular, when the transport vehicle 10 is not moved during maintenance work or the like, it is preferable to use the travel restricting device 1 set in this manner.

(3) In the above embodiment, an example is described in which the distance 82 in the travel direction X between the facing surface 51, which faces the first bumper 14, of the facing section 5 and the leading end portion 42 of the underlay section on the approaching side X1 in the travel direction is less than or equal to the distance 83 between the axis P of the wheel 11 and the end portion 16 of the first bumper 14 on the distancing side X2 in the travel direction, but the present invention is not limited to this. The distance 82 in the travel direction X between the facing surface 51 and the leading end portion 42 can also be set larger than the distance 83 between the axis P of the wheel 11 and the end portion 16 of the first bumper 14 on the distancing side X2 in the travel direction. With this configuration, from the state where, for example, the underlay section 41 is being pressed under the wheel 11, the wheel 11 travels toward the facing surface 51, and then the first bumper 14 and the facing surface 51 come into contact with each other.

(4) In the above embodiment, an example is described in which the facing section 5 includes the fixed facing member 53 that is fixed to the mounting section 4, and the detachable facing member 55 that is arranged on the approaching side X1 of the fixed facing member 53 in the travel direction and is detachably attached to the mounting section 4, but the present invention is not limited to this. The facing section 5 may be configured without the detachable facing member 55. For example, a configuration is possible in which the facing section 5 includes the fixed facing member 53, and the facing surface 51 is the surface of the fixed facing member 53 that faces the approaching side X1 in the travel direction.

(5) In the above embodiment, an example is described in which the width 84 of the detachable facing member 55 in the width direction Y is larger than the width 85 of the travel rail 20 in the width direction Y, but the present invention is not limited to this. The width 84 of the detachable facing member 55 in the width direction Y may be less than or equal to the width 85 of the travel rail 20 in the width direction Y.

(6) In the above embodiment, an example is described in which the mounting section 4 includes the pair of guide sections 44 arranged outward of the travel rail 20 on opposite sides in the width direction Y, but the present invention is not limited to this. The mounting section 4 may include one guide section 44 only on one side of the travel rail 20 in the width direction Y. Furthermore, the mounting section 4 may be configured without the pair of guide sections 44.

(7) In the above embodiment, an example is described in which the underlay section 41 includes the plate-shaped section 46 that is shaped as a plate extending along the travel surface 21, and the tapered section 47 that is arranged on the approaching side X1 of the plate-shaped section 46 in the travel direction and has the upper surface 47a that is inclined downward while extending toward the approaching side X1 in the travel direction, but the present invention is not limited to this. The underlay section 41 may be configured without the tapered section 47.

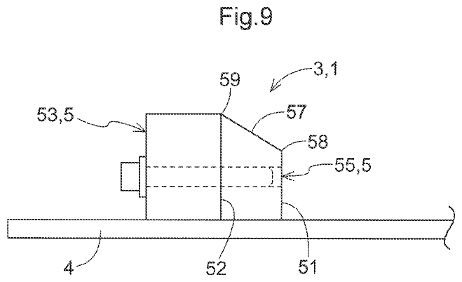

(8) In the above embodiment, an example is described in which the facing section 5 includes the inclined upper surface 57, which is an upper surface that is inclined upward while extending toward the distancing side X2 in the travel direction, but the present invention is not limited to this. For example, the facing section 5 may be configured without the inclined upper surface 57. Also, in the above embodiment, an example is described in which the inclined upper surface 57 extends in a continuous manner from the upper end of the facing surface 51 of the detachable facing member 55, and the upper surface of the detachable facing member 55 that extends along the horizontal plane extends in a continuous manner from the upper end of the inclined upper surface 57, but the present invention is not limited to this. For example, as shown in FIG. 9, the entirety of the upward facing surface of the detachable facing member 55 may be the inclined upper surface 57. Note that in the example shown in FIG. 9, unlike the above embodiment, the entirety of the downward facing surface of the detachable facing member 55 extends along the horizontal plane. Also, the inclined upper surface 57 may extend over both the fixed facing member 53 and the detachable facing member 55.

(9) In the above embodiment, an example is described in which the reference mark 6 is provided on the upper surface 43 of the mounting section 4 to indicate a reference position of the mounting section 4 relative to the first bumper 14, but the present invention is not limited to this. The reference mark 6 does not need to be provided on the upper surface 43 of the mounting section 4. Furthermore, in the above embodiment, an example is described in which a groove-shaped scribing line extending along the width direction Y is formed on the upper surface 43 of the mounting section 4 as the reference mark 6, but a configuration is possible in which the reference mark 6 is a sticker marked with the scribing line, and the position of the reference mark 6 can be changed in accordance with the size of the wheel 11 by affixing the sticker to the upper surface 43 of the mounting section 4 at an appropriate position.

(10) It should be noted that the configurations disclosed in each of the above-described embodiments can also be applied in combination with configurations disclosed in other embodiments (including combinations between embodiments described as other embodiments) as long as no contradiction arises. Regarding such other configurations as well, the embodiments disclosed in this specification are merely examples in all respects. Therefore, various modifications can be made as appropriate without departing from the spirit of the present disclosure.

### Overview of Embodiments

The following is an overview of embodiments pertaining to the travel restricting device described above.

A travel restricting device according to an aspect of the present disclosure is configured to restrict traveling of a transport vehicle configured to travel along a travel rail in a transport facility that includes the transport vehicle and the travel rail, the transport vehicle including a wheel configured to roll on a travel surface of the travel rail, a drive device configured to drive the wheel, and a bumper configured to cause the drive device to undergo an emergency stop in response to a collision with an obstacle, the travel restricting device including:
a mounting section configured to be mounted on the travel surface; and
a standing section configured to be fixed to the mounting section and extend upward beyond the travel surface,
with a travel direction being a direction along the travel rail, a distancing side in the travel direction being a side corresponding to movement away from the wheel in the travel direction, and an approaching side in the travel direction being a side corresponding to movement toward the wheel in the travel direction,
the standing section including a facing section configured to be arranged at a position facing the bumper from the distancing side in the travel direction while the mounting section is mounted on the travel surface, and
the mounting section including an underlay section configured to be positioned relative to the facing section in such a manner that the underlay section is pressed under the wheel while the bumper is in contact with the facing section.

According to this configuration, when work is to be performed by a worker or the like in the vicinity of the transport vehicle while the transport vehicle is stopped, the travel restricting device is installed such that the mounting section is mounted on the travel surface, and therefore even if the transport vehicle unexpectedly starts traveling, the transport vehicle can be stopped immediately. In other words, when the transport vehicle travels and the bumper comes into contact with the facing section, the underlay section of the mounting section becomes pressed under the wheel. Since the facing section is fixed to the mounting section, the facing section does not move when pushed by the transport vehicle, and the bumper can be pushed by the facing section. Therefore, the drive device of the transport vehicle can be reliably brought to an emergency stop.

In this way, according to the above configuration, even if the transport vehicle unexpectedly starts traveling, the transport vehicle can be quickly brought to an emergency stop.

It is preferable that the facing section includes a facing surface configured to face the bumper,
the underlay section includes a leading end portion on the approaching side in the travel direction, and
the facing surface and the leading end portion are spaced apart from each other in the travel direction by a distance set in such a manner that, while (i) the underlay section is not pressed under the wheel and (ii) the leading end portion is in contact with an outer circumferential surface of the wheel, the facing surface and the bumper are in contact with each other, or the facing surface and the bumper face each other across a gap.

According to this configuration, the travel restricting device is installed at a position where the leading end portion of the underlay section on the approaching side in the travel direction comes into contact with the outer circumferential surface of the wheel, and thus the facing section comes into contact with the bumper or faces the bumper across a gap. Therefore, even if the transport vehicle unexpectedly starts traveling, the transport vehicle can be stopped while suppressing the travel distance of the transport vehicle to a minimum.

Also, it is preferable that the facing section includes a facing surface configured to face the bumper,
the underlay section includes a leading end portion on the approaching side in the travel direction, and
the facing surface and the leading end portion are spaced apart from each other in the travel direction by a distance less than or equal to a distance between an axis of the wheel and an end portion of the bumper on the distancing side in the travel direction.

According to this configuration, for example, if the travel restricting device is installed at a position where the leading end portion of the underlay section on the approaching side in the travel direction comes into contact with the outer circumferential surface of the wheel, the facing section is arranged so as to face the bumper across a slight gap. Therefore, even if the transport vehicle unexpectedly starts traveling, the transport vehicle can be stopped while suppressing the travel distance of the transport vehicle to a minimum.

Also, it is preferable that the facing section includes:
a fixed facing member fixed to the mounting section; and
a detachable facing member configured to be detachably attached to the mounting section on the approaching side of the fixed facing member in the travel direction,
the detachable facing member includes a facing surface configured to face the bumper from the distancing side in the travel direction, and
the fixed facing member includes an auxiliary facing surface configured to face the bumper from the distancing side in the travel direction while the detachable facing member is not attached.

According to this configuration, even if the transport vehicle unexpectedly starts traveling and then stops in the state where the bumper is pressed by the facing surface of the detachable facing member, a gap can be provided between the bumper and the fixed facing member of the facing section by detaching the detachable facing member. Therefore, it becomes possible to easily perform the task of canceling the emergency stop of the drive device and resuming the traveling of the transport vehicle.

Furthermore, according to the above configuration, even when the detachable facing member is detached, the fixed facing member has the auxiliary facing surface that faces the bumper, and therefore even in the unlikely event that the transport vehicle unexpectedly starts traveling during work for resuming the traveling of the transport vehicle, the bumper can be pressed by the auxiliary facing surface such that the drive device of the transport vehicle is caused to undergo an emergency stop.

Also, it is preferable that the detachable facing member is wider than the travel rail in a width direction orthogonal to the travel direction in a vertical view.

According to this configuration, when the transport vehicle stops in the state where the bumper is being pressed by the facing surface of the detachable facing member, the work of detaching the detachable facing member can be easily performed. For example, the detachable facing member can be easily detached by pushing up the portions of the detachable facing member that protrude from the rail in the width direction from below.

Also, it is preferable that the mounting section further includes a pair of guide sections configured to be arranged outward of the travel rail on opposite sides in a width direction orthogonal to the travel direction in a vertical view, and each of the guide sections includes a guide surface configured to face a corresponding side surface of the travel rail.

According to this configuration, the travel restricting device can be easily arranged at an appropriate position relative to the travel rail in the width direction, and it is also possible to prevent the travel restricting device from shifting in the width direction after arrangement.

Also, it is preferable that the underlay section further includes:
a plate-shaped section shaped as a plate extending along the travel surface; and
a tapered section on the approaching side of the plate-shaped section in the travel direction and having an upper surface extending downward toward the approaching side in the travel direction.

According to this configuration, even if the transport vehicle unexpectedly starts traveling, it is easy to suppress vibration caused when the wheel rides onto the underlay section. Therefore, it is possible to reduce the possibility that the behavior of the transport vehicle becomes unstable due to vibration caused when the wheel rides onto the underlay section.

Also, it is preferable that the facing section further includes an inclined upper surface inclined obliquely upward toward the distancing side in the travel direction, the transport vehicle further includes a wheel support member supporting the wheel, the facing section is arranged in such a manner that an end portion of the inclined upper surface on the approaching side in the travel direction is lower than a lower end portion of the wheel support member on the distancing side in the travel direction, and the facing section is arranged such that an end portion of the inclined upper surface on the distancing side in the travel direction is higher than the lower end portion of the wheel support member.

According to this configuration, even if the transport vehicle unexpectedly starts traveling and does not stop even though the bumper comes into contact with the facing section, the wheel support member is able to ride onto the tapered upper surface, thus making it possible to lift the wheel and stop the transport vehicle from traveling.

Also, it is preferable that the mounting section includes an upper surface provided with a reference mark indicating a reference for an installation position of the mounting section relative to the bumper,
the facing section includes a facing surface configured to face the bumper, and
the reference mark is arranged at a position spaced apart from the facing surface by an allowable travel distance that is an upper limit of a distance the transport vehicle is allowed to travel.

According to this configuration, by installing the travel restricting device such that the leading end of the bumper is between the facing section and the reference mark, the travel restricting device can be easily installed at a position where, even if the transport vehicle unexpectedly starts traveling, the transport vehicle can be appropriately stopped while minimizing the travel distance of the transport vehicle.

The travel restricting device according to the present disclosure need only be able to achieve at least one of the effects described above.

What is claimed is:

1. A travel restricting device configured to restrict traveling of a transport vehicle configured to travel along a travel rail in a transport facility that includes the transport vehicle and the travel rail, the transport vehicle comprising a wheel configured to roll on a travel surface of the travel rail, a drive device configured to drive the wheel, and a bumper configured to cause the drive device to undergo an emergency stop in response to a collision with an obstacle, the travel restricting device comprising:
a mounting section configured to be mounted on the travel surface; and
a standing section configured to be fixed to the mounting section and extend upward beyond the travel surface, and
wherein:
a travel direction is a direction along the travel rail, a distancing side in the travel direction is a side corresponding to movement away from the wheel in the travel direction, and an approaching side in the travel direction is a side corresponding to movement toward the wheel in the travel direction,
the standing section comprises a facing section configured to be arranged at a position facing the bumper from the distancing side in the travel direction while the mounting section is mounted on the travel surface, and
the mounting section comprises an underlay section configured to be positioned relative to the facing section in such a manner that the underlay section is pressed under the wheel while the bumper is in contact with the facing section.

2. The travel restricting device according to claim 1, wherein:
the facing section comprises a facing surface configured to face the bumper,
the underlay section comprises a leading end portion on the approaching side in the travel direction, and
the facing surface and the leading end portion are spaced apart from each other in the travel direction by a distance set in such a manner that, while (i) the underlay section is not pressed under the wheel and (ii) the leading end portion is in contact with an outer circumferential surface of the wheel, the facing surface and the bumper are in contact with each other, or the facing surface and the bumper face each other across a gap.

3. The travel restricting device according to claim 1, wherein:
the facing section comprises a facing surface configured to face the bumper,
the underlay section comprises a leading end portion on the approaching side in the travel direction, and
the facing surface and the leading end portion are spaced apart from each other in the travel direction by a distance less than or equal to a distance between an axis of the wheel and an end portion of the bumper on the distancing side in the travel direction.

4. The travel restricting device according to claim 1, wherein:
the facing section comprises:
a fixed facing member fixed to the mounting section; and
a detachable facing member configured to be detachably attached to the mounting section on the approaching side of the fixed facing member in the travel direction,
the detachable facing member comprises a facing surface configured to face the bumper from the distancing side in the travel direction, and
the fixed facing member comprises an auxiliary facing surface configured to face the bumper from the distancing side in the travel direction while the detachable facing member is not attached.

5. The travel restricting device according to claim 4,
wherein the detachable facing member is wider than the travel rail in a width direction orthogonal to the travel direction in a vertical view.

6. The travel restricting device according to claim 1,
wherein the mounting section further comprises a pair of guide sections configured to be arranged outward of the travel rail on opposite sides in a width direction orthogonal to the travel direction in a vertical view, and
wherein each of the guide sections comprises a guide surface configured to face a corresponding side surface of the travel rail.

7. The travel restricting device according to claim 1,
wherein the underlay section further comprises:
a plate-shaped section shaped as a plate extending along the travel surface; and
a tapered section on the approaching side of the plate-shaped section in the travel direction and having an upper surface extending downward toward the approaching side in the travel direction.

8. The travel restricting device according to claim 1, wherein:
the facing section further comprises an inclined upper surface inclined obliquely upward toward the distancing side in the travel direction,
the transport vehicle further comprises a wheel support member supporting the wheel,
the facing section is arranged in such a manner that an end portion of the inclined upper surface on the approaching side in the travel direction is lower than a lower end portion of the wheel support member on the distancing side in the travel direction, and
the facing section is arranged such that an end portion of the inclined upper surface on the distancing side in the travel direction is higher than the lower end portion of the wheel support member.

9. The travel restricting device according to claim 1, wherein:
the mounting section comprises an upper surface provided with a reference mark indicating a reference for an installation position of the mounting section relative to the bumper,
the facing section comprises a facing surface configured to face the bumper, and
the reference mark is arranged at a position spaced apart from the facing surface by an allowable travel distance that is an upper limit of a distance the transport vehicle is allowed to travel.
